(19) United States
(12) Patent Application Publication
(10) Pub. No.: US 2010/0074598 A1
(43) Pub. Date: Mar. 25, 2010

(54) SYSTEM AND METHOD OF PRESENTING MULTI-DEVICE VIDEO BASED ON MPEG-4 SINGLE MEDIA

(76) Inventors: Hyun-Woo Oh, Daejeon (KR); Hae Ryong Lee, Daejeon (KR); Kwang Roh Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/429,790

(22) Filed: Apr. 24, 2009

(30) Foreign Application Priority Data
Sep. 25, 2008 (KR) 10-2008-0094063

(51) Int. Cl. H04N 7/26; H04N 7/173

(52) U.S. Cl. 386/124; 725/114; 386/E05.001

(57) ABSTRACT

A system for presenting real-sense effect of multi-device video based on MPEG-4 single media includes a transmission apparatus for extracting objects from MPEG-4 media, analyzing behavior patterns of the objects to recognize situation of the behavior patterns of the objects based on an ontology profile, generating real-sense effect metadata depending on the recognized situation, and producing the real-sense effect metadata, the ontology profile and the MPEG-4 media along with document and action script into a single media for the transmission thereof; and reception apparatus for extracting, upon receipt the single media, the real-sense effect metadata from the received single media, collecting real-sense effect devices existing in reproduction environments, analyzing how to control any of the real-sense effect devices based on the ontology profile, and presenting the real-sense effect by using the real-sense effect devices.

### CROSS-REFERENCE(S) TO RELATED APPLICATION(S)

The present invention claims priority of Korean Patent Application No. 10-2008-0094063, filed on Sep. 25, 2008, which is incorporated herein by reference.

### FIELD OF THE INVENTION

The present invention relates to presentation of multi-device video based on MPEG-4 single media, and more particularly, to a system and method for presenting multi-device video based on MPEG-4 single media.

### BACKGROUND OF THE INVENTION

One of related arts describes a method for extracting device control metadata from media through a home server system that plays the media and for controlling a known device based on the extracted device control metadata, wherein the media contains the device control metadata produced in advance on the offline.

This method allows for a prior knowledge of how a person who edits media should control which device, and is to insert this into the media in the form of device control metadata. It also enables a home server that plays the media to know devices that have been already connected thereto and to control the devices based on the device control metadata.

In such a conventional method, however, since the metadata is structured for device control rather than for real-sense effect, a device indicated by the metadata must necessarily match a device that exists within a space for presentation. Therefore, if additional devices are newly connected to a home server or devices connected to a home server are modified, the devices may not be controlled by the metadata for device control contained in the media. In addition, it fails to meet the general premise that a user who watches the same real-sense effect media does not have the same device.

As another related art, there is a technique which allows devices with diverse functions to be converged themselves through media having a new structure (“ne-media”) and provides users with realistic media services, regardless of users' physical locations such as homes, offices, public places and so on, by generating the ne-media capable of adding device control and synchronization information for real-sense services to the existing media consisting of video, audio, and text, and inserting real-sense presentation information suitable for personal taste and ambient device environments into the new media for transmission to peripheral real-sense devices.

However, this technique is employed under the environment in which the ne-media for representation is produced by adding the device control and synchronization metadata to the media on the offline, which is nothing but a general one that extracts device control and synchronization metadata from the ne-media and controls real-sense devices along with presentation of the ne-media. Therefore, since it employs the metadata for device control as mentioned in the above article, there is a limitation in that a device indicated by the metadata should necessarily match a device that exists within a space for presentation. Thus, such a technique cannot control any newly added device and other devices.

### SUMMARY OF THE INVENTION

It is, therefore, an object of the present invention to provide a system and method of presenting multi-device video based on MPEG-4 single media. In accordance with a first aspect of the present invention, there is provided a system for presenting real-sense effect of multi-device video based on MPEG-4 single media, comprising:

a transmission apparatus for extracting objects from MPEG-4 media, analyzing behavior patterns of the objects to recognize situation of the behavior patterns of the objects based on an ontology profile, generating real-sense effect metadata depending on the recognized situation, and producing the real-sense effect metadata, the ontology profile and the MPEG-4 media along with document and action script into a single media for the transmission thereof; and

a reception apparatus for extracting, upon receipt the single media, the real-sense effect metadata from the received single media, collecting real-sense effect devices existing in reproduction environments, analyzing how to control any of the real-sense effect devices based on the ontology profile, and presenting the real-sense effect by using the real-sense effect devices.

In accordance with a second aspect of the present invention, there is provided a method for presenting real-sense effect of multi-device video based on MPEG-4 single media comprising:

receiving MPEG-4 media, document, and action script defining actions required for the presentation of the MPEG-4 media;

extracting objects from the MPEG-4 media;

analyzing behavior patterns of the objects;

recognizing situation of the analyzed behavior patterns of the objects by using an ontology profile;

generating real-sense metadata to control one or more real-sense effect devices based on the recognized situation;

generating the real-sense metadata, the ontology profile, the MPEG-4 media, the document and the action script into a single media;

transmitting the single media through broadcasting media;

receiving the single media;

extracting the real-sense metadata from the single media;

selecting any of real-sense effect devices based on the real-sense effect metadata;

generating a command to control the selected real-sense effect devices based on the real-sense effect metadata and the ontology profile; and

reproducing the single media by controlling the selected real-sense effect devices in response to the control command.

### BRIEF DESCRIPTION OF THE DRAWINGS

The above and other objects and features of the present invention will become apparent from the following description of preferred embodiments, given in conjunction with the accompanying drawings, in which:

FIG. 1 illustrates a block diagram of a system for presenting multi-device video based MPEG-4 single media in accordance with an embodiment of the present invention;

FIG. 2 shows a flow chart of a process for transmission of multi-device video in accordance with an embodiment of the present invention; and

FIG. 3 provides a flow chart of a process for reception of multi-device video in accordance with an embodiment of the present invention.

### DETAILED DESCRIPTION OF THE EMBODIMENT

Hereinafter, the operational principle of the present invention will be described in detail with reference to the accompanying drawings. In the following description, well-known functions or constitutions will not be described in detail if they would obscure the invention in unnecessary detail. Further, the terminologies to be described below are defined in consideration of functions in the present invention and may vary depending on a user's or operator's intention or practice. Thus, the definitions should be understood based on all the contents of the specification.

As will be described below, the present invention proposes a technique, which, in a transmission process, extracts objects from media, documents and action scripts in MPEG-4 format, analyzes motion and behavior patterns of the objects, recognizes situation of the analyzed patterns based on ontology profiles about environment and devices, and creates corresponding real-sense effect metadata to produce and transmit combined media; and, in a reception process, receives transmitted media to extract real-sense effect metadata, analyzes real-sense effect devices to be controlled by using device-related collection information and ontology profiles that are under the environment, and generates a control command to represent real-sense effect devices along with the MPEG-4 media, documents, through which all the objects defined herein can easily be achieved.

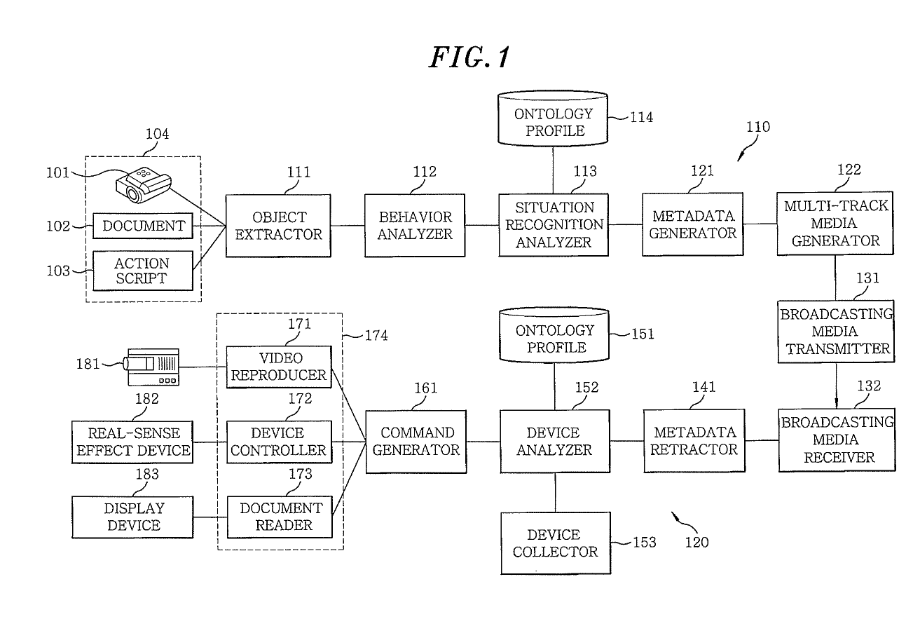

FIG. 1 illustrates a block diagram of a system for presenting real-sense effect of multi-device video based MPEG-4 single media in accordance with an embodiment of the present invention. As shown in FIG. 1, the system is partitioned into two parts, that is, an apparatus 110 for transmission of multi-device video, and an apparatus 120 for reception of multi-device video.

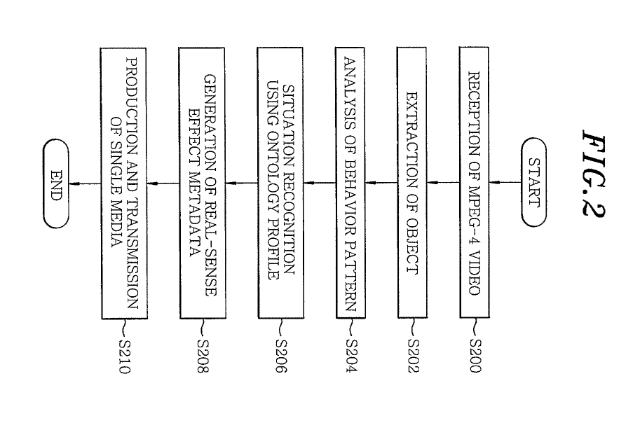

Hereinafter, an operation of each component in the apparatus 100 of the real-sense effect presentation system will be described in detail with reference to FIG. 1 and FIG. 2 showing a flow chart of a process for transmission of multi-device video.

First, in step S200, the inventive apparatus for transmission of multi-device video based MPEG-4 single media receives, through an input unit 104, an MPEG-4 media captured by a camera 101, a previously produced document 102, and an action script 103 defining actions required for the presentation of the document or MPEG-4 media.

Next, in step S202, objects that belong to each scene constituting the MPEG-4 media received through the input unit 104 are extracted by an object extractor 111 on a scene basis. For example, a teacher who teaches in e-running, and a beam pointer or mouse held by the teacher may be extracted as the objects. In a subsequent step S204, each of the objects so extracted is subject to analyze behavior patterns thereof by a behavior analyzer 112. For example, a behavior pattern, such as “a teacher directed his or her hand towards a screen and a beam pointer is pressed”, may be analyzed.

An ontology profile stores the definition of detailed motions of the objects. For example, in an ontology profile 114, the actions “an entity such as a professor stretches out his or her arm within a room space” and “an entity of a beam pointer is pressed” are defined. Then, based on the ontology profile, a situation recognition analyzer 113 recognizes an overall situation depending on the analysis result of behavior patterns, e.g., “the professor points at a specific area of a certain document to be presented with a beam pointer for learning”, in step S206.

In a following step S208, a metadata generator 121 produces real-sense effect metadata to control one or more real-sense effect devices which will represent the MPEG-4 media based on the recognized situation. For example, if there is any document that needs the insertion of a beam pointing effect when the professor activates the beam pointer, the metadata generator 121 generates real-sense effect metadata to make sure that a beam is pointing to a certain location of the corresponding document. Here, the corresponding document may be a document received from the input unit 104, for example, a document created with MicroSoft power point for lessons. Also, the action script may describe the following instructions: “when a beam pointer is activated, let it illuminate a document instead of a video on the screen”, or “when a beam pointer is activated, let it illuminate a document on the entire screen and a video on the right corner of the document screen in 25% size”.

Lastly, in step S210, when the real-sense effect metadata is generated, a multiple track media generator 122 makes the MPEG-4 media, real-sense effect metadata, document, action script, ontology profile, and so on into a MPEG-4 single media, and then, a broadcasting media transmitter 131 transmits the MPEG-4 single media made by the multiple track media generator 122.

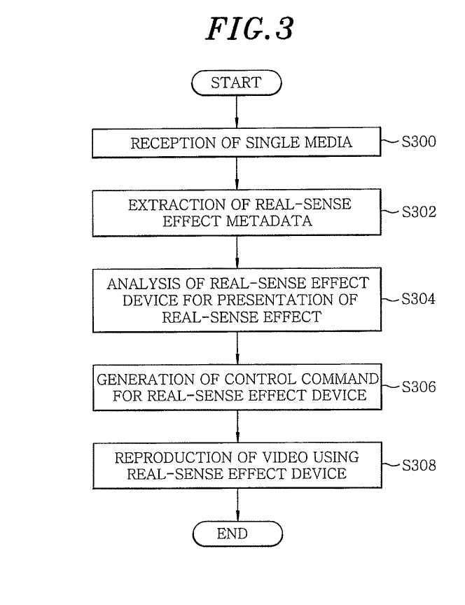

Now, an operation of each component in the reception apparatus 200 in the real-effect presentation system will be described in detail with reference to FIG. 1 and FIG. 3 showing a flowchart of a process for reception of multi-device video.

In the apparatus for reception of multi-device video based on MPEG-4 single media, in step S300, a broadcasting media receiver 132 receives MPEG-4 single media into which MPEG-4 media, real-sense effect metadata, document, action script, ontology profile, and so on are incorporated. Then, in step S302, a metadata extractor 141 extracts real-sense effect metadata from the MPEG-4 single media. At this time, since basic media parsing is done during extracting the real-sense effect metadata from the MPEG-4 single media, MPEG-4 media, document, action script and ontology profile are naturally sorted.

Thereafter, a device collector 153 checks whether there is any real-sense effect device in the environment where the MPEG-4 media is being produced, and if any, performs collection and management thereon. Here, a separate protocol is used for exchanging real-sense effect control information among real-sense effect device 182 and the device collector 153. More specifically, the device collector 153 establishes and manages a database for information, indicating a list of the collected real-sense effect devices 182, that they can achieve certain real-sense effects, and about how to control them for the purpose of the real-sense effects.

Meanwhile, an ontology profile 151 may be implemented with the same ontology profile 114 as that was used for producing the MPEG-4 single media or with another ontology profile more suitable for the environment where the MPEG-4 single media is being produced. In this manner, by making the ontology profile modifiable, different real-sense effects can be acquired for the same MPEG-4 media.

Next, in step S304, a device analyzer 152 analyzes which real-sense device can maximize the real-sense effect described in the real-sense effect metadata based on the ontology profile 151, and analyzes about when and how to control it. And then, in step S306, a command generator 161 generates a command to control the real-sense effect device based on the analysis result acquired by the device analyzer 152. At this time, the command generator 161 may also generate a command to make a screen change, or to control a video location or a screen size with reference to the action script.

Lastly, in step S308, when any real-sense effect device is selected and any control command is generated, the MPEG-4 single media is played back, through the output unit 174, in a video form in which real-sense effect inserted at the time of presentation thereof is reproduced as it is.

The output unit 174 includes, for example, a video player 171, a device controller 172, a document reader 173, and the like. The video player 171 plays a projector 181, and the device controller 172 controls the real-sense effect device 182 in response to the control command from the command generator 161.

Also, the document reader 173 outputs the corresponding document through the display device 183. For example, if there is real-sense effect metadata related to beam pointing, the device collector 153 provides information about a real-sense effect device that can achieve a beam pointing effect, and the device analyzer 152 analyzes if the real-sense effect device for the beam pointing effect should radiate which amount of beam in which direction and in which degree of strength, based on the ontology profile 151.

The command generator 161 generates commands to read the document upon pressure of a beam pointer, to control a location and size of a video for the document so that the beam pointing location thereon is not hidden with others, and to control the real-sense effect device. Then, the device controller 172 controls the real-sense effect device for the beam pointing effect, and the document reader 173 outputs the document to the display device 183 for its display.

As described above, the present invention allows a user who enjoys media to take much more the enjoyment that watches it, by means of controlling multiple real-sense effect devices based on real-sense effect metadata contained in single media to make peripheral real-sense effect devices operate in synchronism with the single media. In addition, the present invention extracts a specific object contained in source media, analyzes a behavior pattern of the object, and recognizes situation of the behavior pattern based on ontology profile, thereby generating real-sense effect metadata.

Moreover, the present invention can make a differentiation about situation recognition results of the behavior pattern of the same object by modifying the ontology profile even for the same source media. Thus, the present invention can generate the corresponding real-sense effect metadata and know which real-sense effect devices exist in the environment that plays the single media. As a result, it becomes possible to analyze how to control which device to represent any real-sense effect based on the real-sense effect metadata, so as to control the corresponding real-sense effect device.

Also, the present invention integrally processes not only videos but also documents and action scripts to represent media as well as documents and actions described thereon, thereby providing more real-sense effects.

While the invention has been shown and described with respect to the particular embodiments, it will be understood by those skilled in the art that various changes and modification may be made without departing from the scope of the invention as defined in the following claims.

What is claimed is:

1. A system for presenting real-sense effect of multi-device video based on MPEG-4 single media, comprising:
a transmission apparatus for extracting objects from MPEG-4 media, analyzing behavior patterns of the objects to recognize situation of the behavior patterns of the objects based on an ontology profile, generating real-sense effect metadata depending on the recognized situation, and producing the real-sense effect metadata, the ontology profile and the MPEG-4 media along with document and action script into a single media for the transmission thereof; and
a reception apparatus for extracting, upon receipt the single media, the real-sense effect metadata from the received single media, collecting real-sense effect devices existing in reproduction environments, analyzing how to control any of the real-sense effect devices based on the ontology profile, and presenting the real-sense effect by using the real-sense effect devices.

2. The system of claim 1, wherein the transmission apparatus comprises:
an input unit for receiving the MPEG-4 media, the document associated with the MPEG-4 media, and the action script defining actions required for the presentation of the MPEG-4 media;
an object extractor for extracting the objects from the MPEG-4 media;
an behavior analyzer for analyzing the behavior patterns of the objects;
an ontology profile for storing the definition of detailed motions of the objects;
a situation recognition analyzer for recognizing situation of the analyzed behavior patterns of the objects based on the ontology profile;
a metadata generator for generating the real-sense effect metadata to control one or more real-sense effect devices which will reproduce the media based on the recognized situation;
a multiple tract media generator for generating the real-sense effect metadata, the ontology profile, the MPEG-4 media, the document and the action script into the single media; and
a broadcasting media transmitter for transmitting the single media through broadcasting.

3. The system of claim 2, wherein the object extractor divides the MPEG-4 media on a scene basis to extract information on each object that belongs to each scene.

4. The system of claim 1, wherein the reception apparatus comprises:
a media receiver for receiving the single media;
a metadata extractor for extracting the real-sense effect metadata from the single media;
a device collector for collecting the real-sense effect devices which will reproduce the single media;
a command generator for generating a command to control any of the real-sense effect devices based on the real-sense effect metadata and the ontology profile; and
an output unit for presenting the single media by controlling the real-sense effect devices, the video player, and the document reader in response to the control command from the control command generator.

5. The system of claim 4, wherein the metadata extractor separates the ontology profile, MPEG-4 media, document, and action script in the single media upon extraction of the real-sense effect metadata.

6. The system of claim 1, wherein the ontology profile is modifiable differently depending on properties of the real-sense effect devices for reproducing of the single media.

7. The system of claim 4, further comprising a device analyzer for selecting any of the collected real-sense effect devices suitable for implementing the real-sense effect based on the real-sense effect metadata and the ontology profile, and analyzes how to control the selected real-sense effect devices.

8. The system of claim 4, wherein the command generator generates a command to make a screen change, or to control a reproduction location of the MPEG-4 media or a screen size with reference to the action script.

9. The system of claim 4, wherein the output unit includes:
a video player for reproducing the MPEG-4 media;
a device controller for controlling the real-sense effect devices based on the ontology profile during the reproduction of the MPEG-4 media; and
a document reader for outputting the document related to the single media.

10. A method for presenting real-sense effect of multi-device video based on MPEG-4 single media comprising:
receiving MPEG-4 media, document, and action script defining actions required for the presentation of the MPEG-4 media;
extracting objects from the MPEG-4 media;
analyzing behavior patterns of the objects;
recognizing situation of the analyzed behavior patterns of the objects by using an ontology profile;
generating real-sense metadata to control one or more real-sense effect devices based on the recognized situation;
generating the real-sense metadata, the ontology profile, the MPEG-4 media, the document and the action script into a single media;
transmitting the single media through broadcasting media;
receiving the single media;
extracting the real-sense metadata from the single media;
selecting any of real-sense effect devices based on the real-sense effect metadata;
generating a command to control the selected real-sense effect devices based on the real-sense effect metadata and the ontology profile; and
reproducing the single media by controlling the selected real-sense effect devices in response to the control command.

11. The method of claim 10, wherein said extracting objects from the MPEG-4 media includes:
dividing the MPEG-4 media on a scene basis; and
extracting the objects that belongs to each scene.

12. The method of claim 10, wherein the ontology profile defines detailed motions of each of the analyzed behavior patterns.

13. The method of claim 10, wherein said extracting real-sense effect metadata from the single media includes separating the ontology profile, the MPEG-4 media, the document, and the action script in the single media upon extraction of the real-sense effect metadata.

14. The method of claim 13, wherein the ontology profile is modifiable differently depending on properties of the real-sense effect devices for the production of the MPEG-4 media.

15. The method of claim 10, wherein said reproducing the single media includes making a screen change, or controlling a presentation location of the MPEG-4 media or a screen size with reference to the action script.
